(19) United States
(12) Patent Application Publication
(10) Pub. No.: US 2011/0273643 A1
(43) Pub. Date: Nov. 10, 2011

(54) LIQUID CRYSTAL DISPLAY DEVICE

(75) Inventors: Norihiro Arai, Tokyo (JP); Kunpei Kobayashi, Tokyo (JP)

(73) Assignee: CASIO COMPUTER CO., LTD., Tokyo (JP)

(21) Appl. No.: 12/940,919

(22) Filed: Nov. 5, 2010

(30) Foreign Application Priority Data
Nov. 9, 2009 (JP) 2009-255903

(51) Int. Cl. G02F 1/1335

(52) U.S. Cl. 349/64

(57) ABSTRACT

A liquid crystal display device includes a liquid crystal panel; a side-lit backlight that emits light towards the liquid crystal panel through a light guide plate, the backlight further having a reflection layer that reflects light that has passed through the liquid crystal panel and the light guide plate in that order; a first λ/4 plate disposed between a first polarizer and the first substrate, the first λ/4 plate having a retarded phase axis that is at a 45° angle with the transmission axis of the first polarizer; a second λ/4 plate disposed between a second polarizer and the second substrate, the second λ/4 plate having a retarded phase axis that is at 45° with the transmission axis of the second polarizer and that is perpendicular to the retarded phase axis of the first λ/4 plate; and a diffusion layer disposed between the first λ/4 plate and the first substrate.

### CROSS-REFERENCE TO RELATED APPLICATIONS

This application is based upon and claims the benefit of priority from prior Japanese Patent Application No. 2009-255903, filed Nov. 9, 2009, the entire contents of which are hereby incorporated by reference.

### BACKGROUND OF THE INVENTION

1. Field of the Invention

The present invention relates to a liquid crystal display device having a side-lit backlight, capable of displaying using the light emitted from the side-lights, and capable of displaying using external light.

2. Description of the Related Art

In recent years, technologies have been disclosed for liquid crystal display devices that are able to perform both transmissive display, wherein the backlight located behind the liquid crystal panel is used as the light source, and reflective display, wherein external light entering into the front side of the liquid crystal panel passes through the liquid crystal layer of the panel and is reflected back into and through the liquid crystal layer to illuminate the display. For example, Japanese Patent Application Laid-Open Publication No. 2004-93715 discloses a technology that enables each display pixel to perform both transmissive display and reflective display by dividing each display pixel into two regions: in one region, pixel electrodes are formed with transparent materials only, and in the other region, pixel electrodes include reflective materials.

The disadvantage of this technology is that, since each display pixel is divided into a transmissive area and a reflective area, only half the area of the pixel is dedicated for each display, and the light available for each purpose also decreases by half. This leads to a dimmer and lower visual quality.

### SUMMARY OF THE INVENTION

The purpose of the present invention is to overcome this disadvantage by providing a liquid crystal display device that can utilize both an external light source and a backlight for display illumination, without dividing pixels into transmissive and reflective areas, resulting in a higher visual quality.

In one aspect, the present invention provides a liquid crystal display device including a liquid crystal panel, including a first substrate having a first electrode thereon, a second substrate having a second electrode thereon, the first electrode on the first substrate facing the second electrode on the second substrate, a liquid crystal layer interposed between the first electrode and the second electrode, the liquid crystal layer including liquid crystal with a negative dielectric constant anisotropy in which liquid crystal molecules are aligned vertically to a substrate surface when 0 V is applied across the first electrode and the second electrode, and are aligned inclinedly in a predetermined direction when a predetermined or higher voltage is applied across the first electrode and the second electrode, and a first polarizer and a second polarizer sandwiching the first substrate and the second substrate therebetween, the first polarizer and the second polarizer having respective transmission axes crossing each other at a right angle; a side-lit backlight that emits light towards the liquid crystal panel through a light guide plate, the backlight further having a reflection layer that reflects light that has passed through the liquid crystal panel and the light guide plate in that order; a first λ/4 plate disposed between the first polarizer and the first substrate, the first λ/4 plate having a retarded phase axis that is at a 45° angle with the transmission axis of the first polarizer; a second λ/4 plate disposed between the second polarizer and the second substrate, the second λ/4 plate having a retarded phase axis that is at 45° with the transmission axis of the second polarizer and that is perpendicular to the retarded phase axis of the first λ/4 plate; and a diffusion layer disposed between the first λ/4 plate and the first substrate.

In another aspect, the present invention provides a liquid crystal display device including a liquid crystal panel, including a first substrate having a first electrode thereon, a second substrate having a second electrode thereon, the first electrode on the first substrate facing the second electrode on the second substrate, a liquid crystal layer interposed between the first electrode and the second electrode, the liquid crystal layer including liquid crystal with a negative dielectric constant anisotropy in which liquid crystal molecules are aligned vertically to a substrate surface when 0 V is applied across the first electrode and the second electrode, and are aligned inclinedly in a predetermined direction when a predetermined or higher voltage is applied across the first electrode and the second electrode, and a first polarizer and a second polarizer sandwiching the first substrate and the second substrate therebetween, the first polarizer and the second polarizer having respective transmission axes crossing each other at a right angle; a side-lit backlight that emits light towards the liquid crystal panel through a light guide plate, the backlight further having a reflection layer that reflects light that has passed through the liquid crystal panel and the light guide plate in that order; a first phase difference generating member disposed between the first polarizer and the first substrate, the first phase difference generating member circularly polarizing light that has passed through the first polarizer; a second phase difference generating member disposed between the second polarizer and the second substrate, the second phase difference circularly polarizing light that has passed through the second polarizer; and a diffusion layer disposed between the first phase difference generating member and the first substrate.

Advantages of the invention will be set forth in the description which follows, and in part will be obvious from the description, or may be learned by practice of the invention.

The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view of a liquid crystal display device.

FIG. 2 is an enlarged cross sectional view of a liquid crystal display device.

FIG. 3 is an explanatory drawing of the relationships among optical axes.

FIG. 4 is a schematic view of the locations of pixel electrodes.

FIG. 5 is an example of the color filter arrangement.

FIG. 6A is an explanatory drawing of the alignment of liquid crystal molecules when 0 V is applied.

FIG. 6B is an explanatory drawing of the alignment of liquid crystal molecules when a predetermined or a higher voltage is applied.

FIG. 7 is an explanatory drawing of the light path from the light emitting elements, guided by the light guide plate.

FIG. 8 is an explanatory drawing of backscattering caused by a diffuser.

FIG. 9 is an enlarged cross sectional view of the prism portion.

FIG. 10 is an explanatory drawing of the paths of the light reflected by the prism portion.

FIG. 11A is an example of the reflection of the sunlight observed with the image of the sun on the display (diffusion layer is not used).

FIG. 11B is an example of the reflection of the sunlight observed with the image of the sun on the display (a diffusion layer having a haze value of 45% is used).

FIG. 11C is an example of the reflection of the sunlight observed with the image of the sun on the display (a diffusion layer having a haze value of 78% is used).

### DETAILED DESCRIPTION OF THE INVENTION

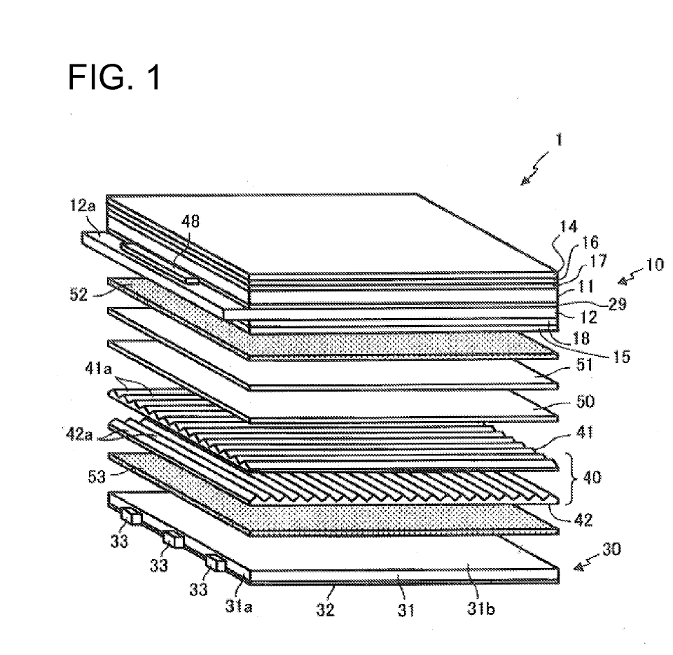

Embodiments of the present invention are described below. Liquid crystal display device 1 of the present invention can illuminate the display by using the side-lit backlight, as well as by using external light, which is reflected by the side-lit backlight. As shown in FIG. 1, liquid crystal display device 1 comprises a liquid crystal panel 10; a light source section 30, which irradiates illumination light to one side of liquid crystal panel 10; a light collection section 40, which is located between light source section 30 and liquid crystal panel 10; a third retarder 50, which is located between light collecting section 40 and liquid crystal panel 10; a reflective polarizer 51, which is located between the third retarder 50 and liquid crystal panel 10, a first diffuser 52, which is located between the reflective polarizer 51 and the liquid crystal panel 10, and a second diffuser 53, which is located between light collection section 40 and light source section 30.

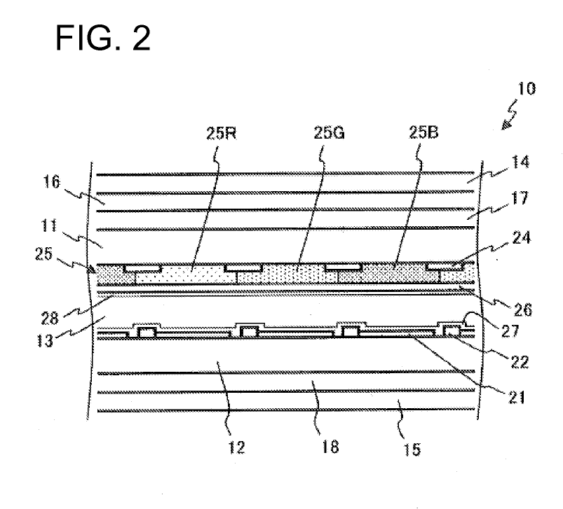

As shown in FIG. 2, liquid crystal panel 10 includes a first transparent substrate 11 and the second transparent substrate 12, which are located opposed to each other and spaced apart from each other by a predetermined distance; a liquid crystal layer 13, which is sealed in between the first transparent substrate 11 and the second transparent substrate 12; a first polarizer 14 and a second polarizer 15, which are located to support the first transparent substrate 11 and the second transparent substrate 12, wherein the transmission axes of the polarizers cross each other at a right angle; the first retarder 16, which is located between the first polarizer 14 and the first transparent substrate 11; a diffusion layer 17, which is located between the first retarder 16 and the first transparent substrate 11; and a second retarder 18, which is located between the second transparent substrate 12 and the second polarizer 15. As described later, the diffusion layer 17 diffuses certain light. The diffusion layer 17 also serves as an adhesive layer through which the first retarder 16 is bonded to the first transparent substrate 11.

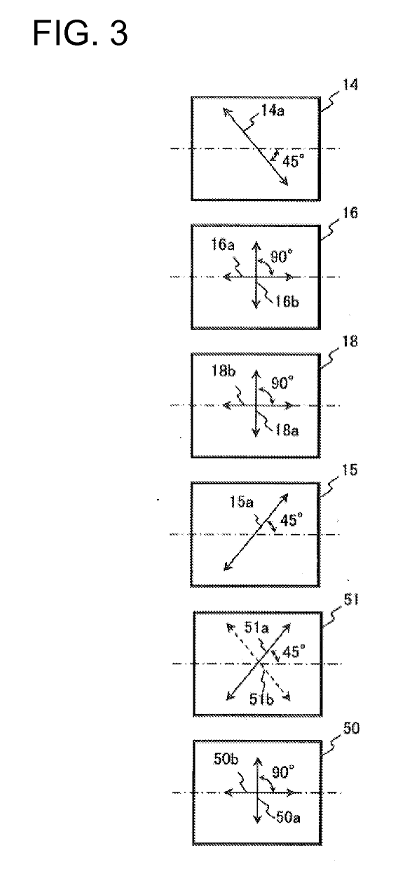

As shown in FIG. 3, the first retarder 16 is disposed so that a retarded phase axis 16a and an advanced phase axis 16b intersect at a right angle, and the retarded phase axis 16a is at a 45° angle with transmission axis 14a of the first polarizer 14. The optical constants for the first retarder 16 are set to provide a phase difference of 1/4 wavelength between the light having a polarization component that is parallel to the retarded phase axis 16a and the light having a polarization component that is parallel to the advanced phase axis 16b. That is, the first retarder 16 is a so-called λ/4 plate, which, by being disposed relative to the first polarizer 14 as described above, serves as a circular polarizer together with the first polarizer 14.

As shown in FIG. 3, the second retarder 18 has a retarded phase axis 18a and an advanced phase axis 18b, which intersect each other at a right angle, and the retarded phase axis 18a is at a 45° angle with transmission axis 15a of the second polarizer 15, and the retarded phase axis 18a is at a 90° angle with retarded phase axis 16a of the first retarder 16. The optical constants for the second retarder 18 are set to provide a phase difference of 1/4 wavelength between the light having a polarization component that is parallel to the retarded phase axis 18a and the light having a polarization component that is parallel to the advanced phase axis 18b. That is, similar to the first retarder 16, the second retarder 18 is a so-called λ/4 plate, which, by being disposed relative to the second polarizer 15 as described above, serves as a circular polarizer together with the second polarizer 15. The arrangement of the second polarizer 15 and the second retarder 18 relative to the first polarizer 14 and the first retarder 16, which has been described above, allows the second retarder 18 and the second polarizer 15 to block the incoming light, circularly polarized to a predetermined direction after passing through, sequentially, the first polarizer 14 and the first retarder 16, entering the second retarder 18. The above-mentioned arrangement of items also allows the first retarder 16 and the first polarizer 14 to block the incoming light, circularly polarized in the predetermined direction after passing through, sequentially, the second polarizer 15 and the second retarder 18, entering into the first retarder 16.

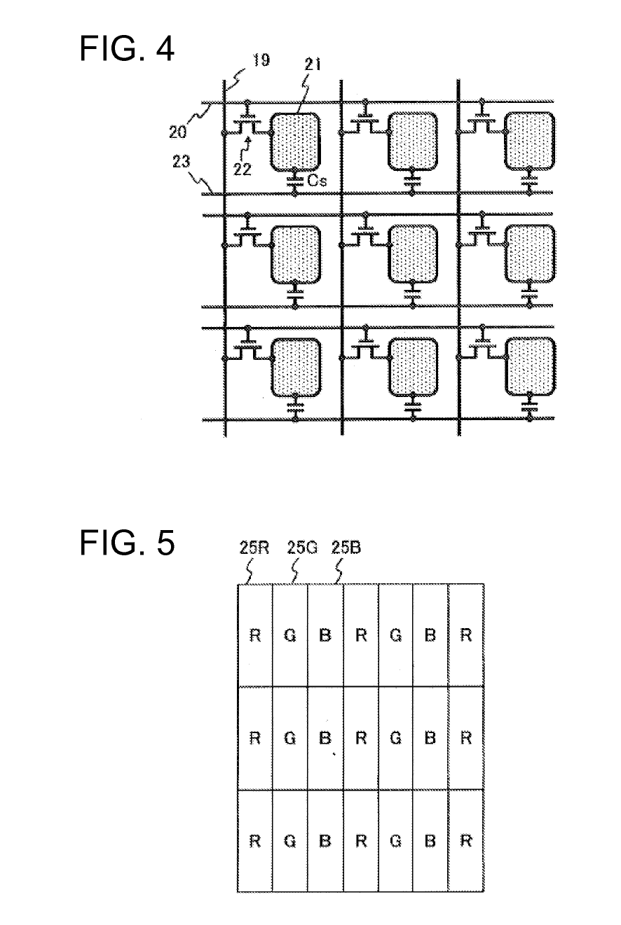

The second transparent substrate 12 has, on the side facing the first transparent substrate 11, as shown in FIG. 4, a plurality of signal lines 19, which are disposed in parallel to one another; a plurality of scanning lines 20, which are intersecting with the plurality of signal lines 19; a plurality of pixel electrodes 21, which are formed of a transparent conductive film such as ITO and are located at the locations corresponding to the intersections of signal lines 19 and scanning lines 20; and a plurality of thin film transistors 22, each of which is disposed for each pixel electrode 21. In other words, a plurality of display pixels are arranged in matrix over the image display area, wherein one pixel electrode 21 and one thin film transistor 22 correspond to each display pixel. Scanning line 20 is formed for each pixel row to send the gate signal to thin film transistor 22. Signal line 19 is formed in correspondence to each pixel column to apply the display signal voltage to pixel electrode 21 through thin film transistor 22.

On the second transparent substrate 12, auxiliary capacitance line 23 is formed for each pixel row. Auxiliary capacitance Cs is formed for each display pixel by the insulating film located between auxiliary capacitance line 23 and pixel electrode 21. Auxiliary capacitance line 23 is set to the same potential as the counter electrode 26 described later.

Thin film transistor 22 has a gate electrode, which is formed on the surface of the second transparent substrate 12; a gate insulating film, which is made of a transparent insulating material and is formed to cover the gate electrode; an i-type semiconductor film, which is formed over the gate insulating film and faces the gate electrode through the gate insulating film; and a drain electrode and a source electrode, each of which are formed on the respective sides of the i-type semiconductor film through an n-type semiconductor film. For each thin film transistor 22, the source electrode is connected to the corresponding pixel electrode 21, the gate electrode is connected to the corresponding scanning line 20, and the drain electrode is connected to the corresponding signal line 19.

As shown in FIG. 2, the first transparent substrate 11 has, on the side facing the second transparent substrate 12, a light shield layer 24 having apertures that approximately correspond to pixel electrodes 21, color filters 25, and a counter electrode 26, which are formed in this order from the first transparent substrate 11. The light shield layer 24 may be formed of a light-shielding metal film or resin film, and the area of the aperture for light transmission is consistent for all display pixels. The area on each pixel electrode 21 that corresponds to the above-mentioned aperture is formed entirely of a transparent conductive film such as ITO. In liquid crystal device 1, both light for transmissive display and light for reflective display pass through this area. In other words, the entire aperture can be used for both transmissive display and reflective display.

Color filters 25 have red color filter 25R for red component, green color filter 25G for green component and blue color filter 25B for blue component. As shown in FIG. 5, for example, a color filter for each color component is provided for each display pixel. The counter electrode 26, made of a transparent conductive film such as ITO, is formed to provide the same potential for all display pixels. For example, counter electrode 26 is formed as one piece film to cover the entire color filter 25 for all display pixels.

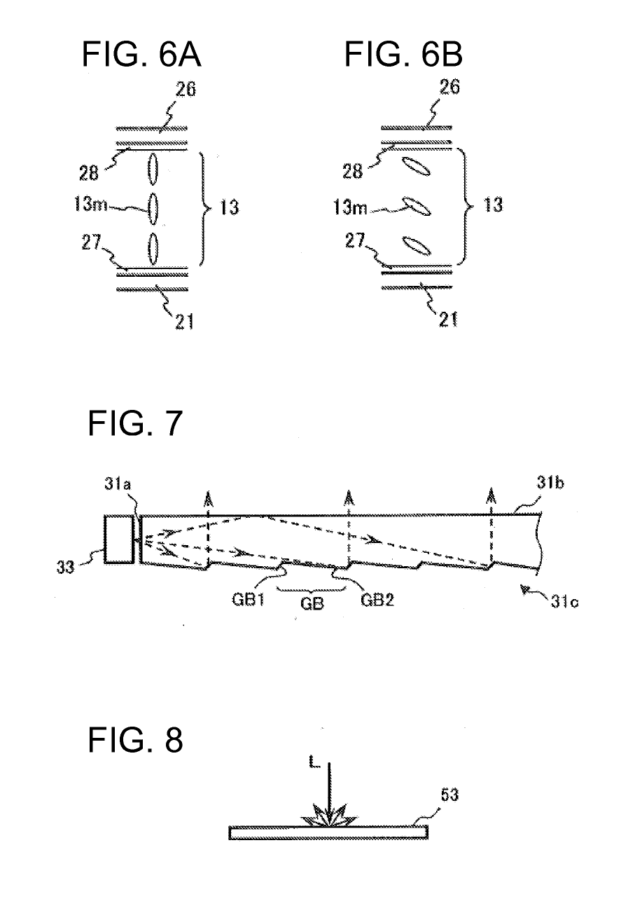

For each display pixel, alignment films 27 and 28 are applied over pixel electrode 21 and counter electrode 26, respectively, for controlling the initial alignment of liquid crystal molecules in liquid crystal layer 13. The alignment films 27 and 28 are, as shown in FIG. 6A, vertical alignment films that align the liquid crystal molecules 13m vertically to the substrate surface when 0 V is applied across the pixel electrode 21 and the counter electrode 26. Liquid crystal layer 13 comprises liquid crystals with negative dielectric constant anisotropy. As shown in FIG. 6B, liquid crystal molecules 13m are aligned to a predetermined direction when a predetermined or higher voltage is applied across the pixel electrode 21 and the counter electrode 26. The higher the voltage applied across the pixel electrode 21 and the counter electrode 26, the further the liquid crystal molecules 13m are aligned horizontally to the substrate surface.

That is, liquid crystal panel 10 is configured in such a way as to prevent the occurrence of an in-plane birefringence in the substrate plane when 0 V is applied across the pixel electrode 21 and the counter electrode 26; to induce an in-plane birefringence in the substrate plane when a predetermined or higher voltage is applied across the pixel electrode 21 and the counter electrode 26; and to induce a larger in-plane birefringence as even higher voltage is applied. Preferably, d·Δn of liquid crystal layer 13, wherein d is the thickness of liquid crystal layer 13 and Δn is the birefringence ratio, is set to less than λ/2. To control the visible light transmission, λ is preferably set to 550 nm, at which the spectral sensitivity of human eyes is believed to be maximized.

When light that is circularly polarized by the first polarizer 14 and the first retarder 16, or by the second polarizer 15 and the second retarder 18 enters liquid crystal layer 13, the light exits liquid crystal layer 13 without being modified when 0 V is applied across the pixel electrode 21 and the counter electrode 26. The circularly polarized light is, then, linearly polarized again by the retarder located at the exit side of liquid crystal layer 13 to the same polarization direction of the light prior to its entry into the liquid crystal layer 13. The light, therefore, is blocked by the polarizer on the exit side. In other words, liquid crystal panel 10 can block the light when 0 V is applied across pixel electrode 21 and counter electrode 26.

On the other hand, when a predetermined or higher voltage is applied across the pixel electrode 21 and the counter electrode 26, the light that has entered liquid crystal layer 13 is polarized according to the alignment angle of liquid crystal molecules 13m, and then exits the liquid crystal layer 13. In this case, the light cannot be linearly polarized again by the retarder located at the exit side of liquid crystal layer 13 to the same polarization direction of the light prior to its entry into the liquid crystal layer 13. The polarizer at the exit side, therefore, lets the light transmit by the amount determined by the alignment angle of liquid crystal molecules. In other words, liquid crystal panel 10 can let the light transmit when a predetermined or higher voltage is applied across the pixel electrode 21 and the counter electrode 26.

When a predetermined or higher voltage is applied across the pixel electrode 21 and the counter electrode 26 as described above, liquid crystal molecules 13m are, as shown in FIG. 6B, aligned to a predetermined direction. Since the light entering liquid crystal layer 13 is circularly polarized, if the alignment angles of all liquid crystal molecules 13m are the same, the light is presented uniform birefringence regardless of the alignment direction of liquid crystal molecules 13m. Therefore, in this embodiment, a high-definition display, free from surface roughness caused by irregular molecule inclination direction, can be obtained.

The first transparent substrate 11 and the second transparent substrate 12 are bonded by a frame-shaped sealing member 29, which surrounds the image display area having a plurality of display pixels arranged therein. Liquid crystal is sealed in the space surrounded by the frame-shaped seal member 29 to form the above-mentioned liquid crystal layer 13.

As shown in FIG. 1, liquid crystal panel 10 in the second transparent substrate 12 of the liquid crystal panel 10, which is facing the first transparent substrate 11 across the liquid crystal layer 13, the driver circuit 48 is mounted on the projected area 12a of the second transparent substrate 12, which area extends beyond one end of the first transparent substrate 11. The driver circuit 48 is electrically connected to a plurality of terminals formed on the projected area 12a, and sends scanning signals to individual scanning lines 20 via these terminals. It also applies display signal voltages to individual signal lines 19, and also applies the common voltage to the auxiliary capacitance line 23 and to the counter electrode 26.

The driver circuit 48 controls the voltage applied across the liquid crystal layer 13 through the pixel electrode 21 and the counter electrode 26. As described earlier, the voltage changes the alignment angle of liquid crystal molecules 13m to control the amount of light transmitted by each display pixel of the liquid crystal panel 1 is controlled.

Liquid crystal panel 10 is configured to let the light originated from the light source section 30 enter liquid crystal layer 13 from the side the second transparent substrate 12 is located.

As shown in FIG. 1, light source section 30 is a so-called side-lit type backlight, which is located at the side opposite from the liquid crystal panel 10, and includes a light guide plate 31, which is larger than the image display area of liquid crystal panel 10 and made of a transparent plate-shaped material; a reflector 32, which is located against the light guide plate 31; and a plurality of the light-emitting elements 33, which emit light towards one of the edge surfaces of light guide plate 31.

The plurality of light-emitting elements 33 emit light when the liquid crystal display device of the present invention is in transmission display mode, wherein the light radiated from light source section 30 is utilized for illumination. Each light-emitting element has red, green, and blue LEDs that generate red, green and blue components, respectively. Light-emitting elements 33 preferably have LEDs that can be turned on/off in response to the brightness of the ambient light surrounding the liquid crystal display device.

Light guide plate 31, as shown in FIG. 7, guides each color component of the light emitted from the light emitting element 33 into the edge surface 31a of the light guide plate 31, to the liquid crystal panel 10 through the main surface 31b (hereinafter “the first main surface 31b”), which is facing the liquid crystal panel 10. A plurality of grooves GB are formed on another main surface 31c, which is facing the first main surface 31b (hereinafter “the second main surface 31c”). The grooves GB are formed in parallel with edge surface 31a to which the light is emitted. The cross section of a groove GB has two sides, GB1 and GB2, which form an apex. GB1 and GB2 have respective different inclination angles against the first main surface 31b of the light guide plate 31. More specifically, side GB1, which is proximal to the light-emitting elements 33, has a larger inclination angle than side GB2.

As shown in dashed lines in FIG. 7, the light generated by the light-emitting element 33 enters the light guide plate 31 through the edge surface 31a. The light is then reflected inwards and directed towards the liquid crystal panel 10 through the first main surface 31b of the light guide plate 31. Light guide plate 31 may be made of a transparent material, such as acrylic, that has a larger refractive index than air, e.g., 1.5.

Reflector 32 reflects the light leaked from the second main surface 31c of the light guide panel 31 back into light guide panel 31, and reflects external light that has entered through liquid crystal panel 10 and light guide plate 31 back to light guide plate 31 and to liquid crystal panel 10. That is, the reflector 32 improves the light utilization efficiency for transmissive display wherein the liquid crystal display device uses the light generated by the light-emitting elements 33; and reflects the external light for reflective display wherein the liquid crystal display device uses external light for illumination. The reflector 32 may be a glass substrate or plastic substrate on which a metal such as silver or aluminum is vapor-deposited.

The second diffuser 53 diffuses the light from the first main surface 31b of the light guide plate 31, to minimize irregular distribution of the light from the light guide plate 31. The second diffuser 53 includes a transparent sheet with light-scattering particles dispersed throughout having a haze value of about 55% to about 85%. As shown in FIG. 8, the second diffuser 53 back-scatters a portion of external light L that has entered from outside and passed through liquid crystal panel 10. The second diffuser 53, therefore, serves as a supplemental reflector for reflective display in which the liquid crystal display device 1 uses external light for illumination.

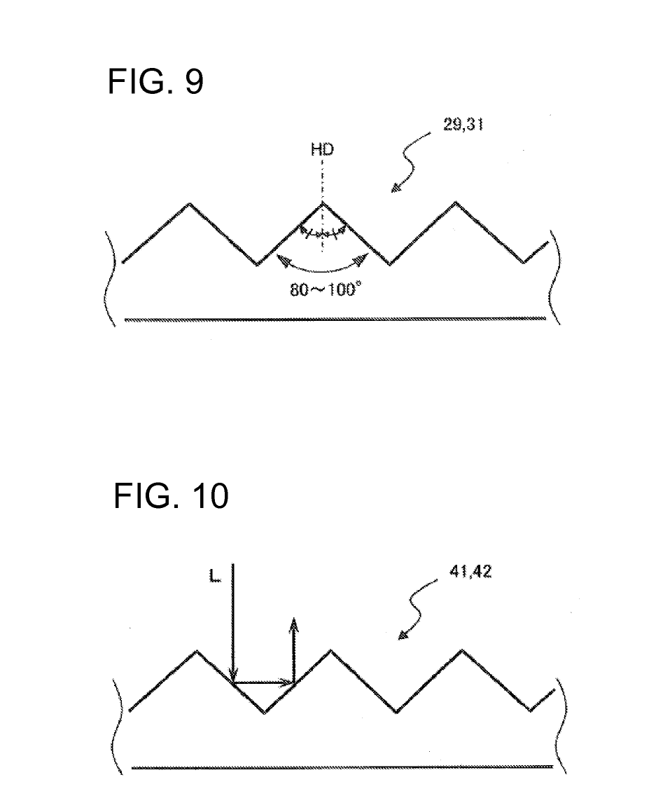

Light collection section 40 is designed to collect the light that was released from light guide plate 31 and then became diffused by the second diffuser 53 on its way to liquid crystal panel 10, and then to guide the collected light towards the liquid crystal panel 10 for efficient utilization of light. The light collection section 40 includes a first prism array 41 and a second prism array 42, which are transparent sheet-like members such as acrylic resin. The first prism array 41 has a plurality of straight lines of prism portions 41a on one side, and the prism portions 41a are arranged in parallel with each other. The first prism array 41 is positioned so that the extending direction of prism portions 41a on the first prism array 41 is perpendicular to the extending direction of grooves GB formed on light guide plate 31, for example. The second prism array 42 has a plurality of straight lines of prism portions 42a on one side, and the prism portions 42a are arranged in parallel with each other. The second prism array 42 is positioned so that the extending direction of the prism portions 42a on the second prism array 42 is parallel to the extending direction of grooves GB formed on the light guide plate 31, for example. As shown in FIG. 9, the prism portions 41a and 42a have a cross section of an isosceles triangle shape which is symmetrical with respect to the normal line HD of liquid crystal panel 10. Here, the apex angle is within a range of about 80° to about 100°, preferably about 90°.

Prism arrays 41 and 42 reflect a portion of external light L that has entered from outside and passed through liquid crystal panel 10, as shown in FIG. 10, with sloping surfaces constituting prism portions 41a and 42a. The prism arrays 41 and 42, therefore, serve as supplemental reflectors for reflective display in which the liquid crystal display device uses external light for illumination.

Reflective polarizer 51, as shown in FIG. 3, has a transmission axis 51a and a reflection axis 51b, which cross each other at a right angle. The reflective polarizer 51 allows components of incoming light that are parallel to the transmission axis 51a transmit, but reflects light components that are parallel to the reflection axis 51b. The reflective polarizer 51 is disposed so that its transmission axis 51a is parallel to the transmission axis 15a of the second polarizer 15.

The third retarder 50, having retarded phase axis 50a and advanced phase axis 50b, which intersect each other at a right angle, is disposed so that the retarded phase axis 50a and the advanced phase axis 50b are at a 45° angle with transmission axis 51a and reflection axis 51b of the reflective polarizer 51. The third retarder 50 is a so-called λ/4 plate, in which the optical constants of the third retarder 50 are set to provide a phase difference of 1/4 wavelength between the light having a polarization component parallel to the retarded phase axis 50a and the light having a polarization component parallel to the advanced phase axis 50b.

The arrangement of the reflective polarizer 51, the third retarder 50, and reflector 32 as described above improves the light utilization efficiency. Of the light originating from the light-emitting elements 33 and passing through the light guide plate 31, the light having a polarization plane that is perpendicular to transmission axis 15a of the second polarizer 15 is first reflected by the reflective polarizer 51 on its way to the crystal panel 10 so as to be modified to become parallel to the transmission axis 15a of the second polarizer 15, and then is redirected to liquid crystal panel 10. The third retarder 50 may be arranged so that the retarded phase axis 50a of the third retarder 50 is parallel or perpendicular to retarded phase axis 16a of the first retarder 16 or retarded phase axis 18a of the second retarder 18.

The first diffuser 52, designed to prevent the occurrence of moire interference between the display pixels on liquid crystal panel 10 and prism arrays 41 and 42 of light collection section 40, includes a transparent sheet dispersed with light-scattering particles for a haze value of about 60% to about 85%. Similar to the second diffuser 53, the first diffuser 52 back-scatters a portion of external light that has entered from outside and passed through liquid crystal panel 10. The first diffuser 52, therefore, serves as a supplemental reflector for reflective display in which the liquid crystal display device 1 uses external light for illumination. The first diffuser 52 may be an adhesive layer that bonds the reflective polarizer 51 to the liquid crystal panel 10. That is, the first diffuser 52 may be an adhesive layer that bonds the reflective polarizer 51 and the second polarizer 15.

In the liquid crystal display device 1 discussed above, the external light can enter liquid crystal device 1 through the liquid crystal panel 10 and advance to light guide plate 31 regardless of the on/off status of light-emitting elements 33 as long as the voltage that enables light transmission through liquid crystal layer 13 is on. This external light that has reached the light guide plate 31 passes through the first main surface 31b of the light guide plate 31 and then the second main surface 31c of the light guide plate 31, bounces off at the reflector 32, and returns to the liquid crystal panel 10 through the second main surface 31c of light guide plate 31 and then the first main surface 3 lb of light guide plate 31. That is, liquid crystal display device 1 is able to perform both transmissive display in which the light generated by the light-emitting element is used for illumination, and reflective display in which the external light is used for illumination, without dividing each display pixel into two regions: one for transmissive display and another for reflective display.

In addition to the reflector 32 in the light source section 30 that reflects the external light, liquid crystal display device 1 uses the first diffuser 52, the second diffuser 53, and prism arrays 41 and 42 as supplemental external light reflectors. In other words, the liquid crystal display device 1 has multiple reflecting planes between liquid crystal panel 10 and reflector 32, which causes a blur in the image of liquid crystal panel 10 projected on reflector 32 by external light. This improves the visual quality by preventing the doubling of the image displayed on the liquid crystal panel 10, which otherwise might take place due to the distance between liquid crystal panel 10 and reflector 32.

In above-mentioned exemplary liquid crystal display device 1, when any portion of the external light L that has passed through the first polarizer 14 and the first retarder 16 is reflected off at the interface such as the surface of the first substrate 11 on the side of the first polarizer 14 prior to the entry into liquid crystal layer 13, the light reflected as circular polarized is being linearly polarized having polarization components in the direction perpendicular to the transmission axis 14a of the first polarizer 14 en route to the first polarizer 14, and thus is blocked by the first polarizer 14. That is, in liquid crystal display device 1, the visibility of the reflective display can be improved because the external light that did not pass through the liquid crystal layer 13 is reflected by the first polarizer 14 and the first retarder 16.

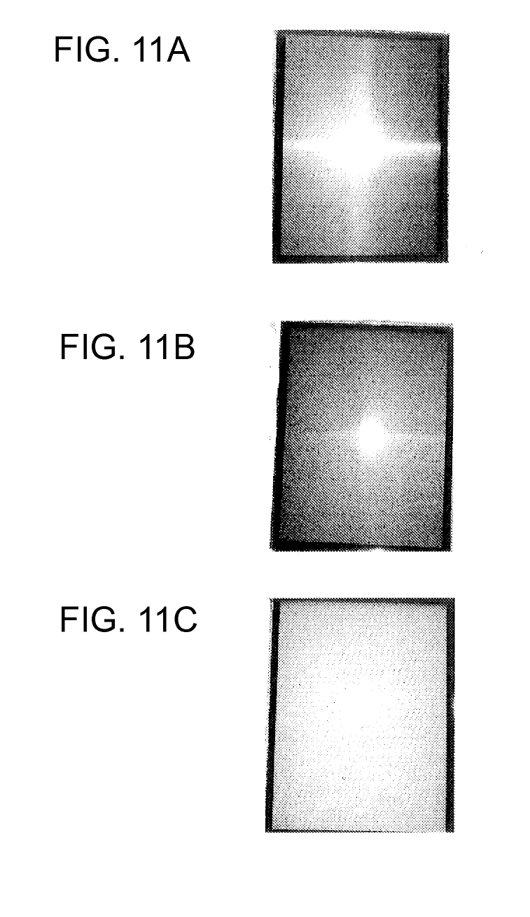

Diffusers 52 and 53 or diffusion layer 17 located before or after liquid crystal layer 13 improves visibility in the reflective display by diffusing external light sufficiently even when reflector 32 is minor-finished for efficient reflection of light from light-emitting elements 33. FIG. 11A, FIG. 11B and FIG. 11C show examples of white displays in the reflective display mode with the image of the sun on the display. FIG. 11A is the case that diffusion layer 17 is not present; FIG. 11B is the case that diffusion layer 17 having a haze value of 45% is present; and FIG. 11C is the case that diffusion layer 17 having a haze value of 78% is present. These examples indicate that diffusion layer 17 having a haze value of at least 45% suppresses the specular reflection of sunlight, which otherwise becomes visible in a shape of a cross for reflective display. The diffusion layer 17 may be disposed between the first polarizer 14 and the first retarder 16. The diffusion layer 17, however, is preferably located near the light shield layer 24, which aperture pattern corresponds to patterns of display pixels in order to maintain high resolution display when utilizing light from the light-emitting element 33. Therefore, diffusion layer 17 is preferably located between the first retarder 16 and the first substrate 11. The surface of the first polarizer 14 on the side of external light entry is preferably formed smooth to prevent light diffusion, and, more preferably, is coated with a reflection preventing material.

Although each light-emitting element 33 is assumed to have red, green and blue LEDs in the embodiment described above, each light-emitting element 33 may have a pseudo-white LED (blue LED+yellow fluorescent material) or high color rendering LED (blue LED+red/green fluorescent material).

What is claimed is:

1. A liquid crystal display device comprising:
a liquid crystal panel, including:
a first substrate having a first electrode thereon,
a second substrate having a second electrode thereon, the first electrode on the first substrate facing the second electrode on the second substrate,
a liquid crystal layer interposed between the first electrode and the second electrode, the liquid crystal layer including liquid crystal with a negative dielectric constant anisotropy in which liquid crystal molecules are aligned vertically to a substrate surface when 0 V is applied across the first electrode and the second electrode, and are aligned inclinedly in a predetermined direction when a predetermined or higher voltage is applied across the first electrode and the second electrode, and
a first polarizer and a second polarizer sandwiching the first substrate and the second substrate therebetween, the first polarizer and the second polarizer having respective transmission axes crossing each other at a right angle;
a side-lit backlight that emits light towards the liquid crystal panel through a light guide plate, the backlight further having a reflection layer that reflects light that has passed through the liquid crystal panel and the light guide plate in that order;
a first λ/4 plate disposed between the first polarizer and the first substrate, the first λ/4 plate having a retarded phase axis that is at a 45° angle with the transmission axis of the first polarizer;
a second λ/4 plate disposed between the second polarizer and the second substrate, the second λ/4 plate having a retarded phase axis that is at 45° with the transmission axis of the second polarizer and that is perpendicular to the retarded phase axis of the first λ/4 plate; and
a diffusion layer disposed between the first λ/4 plate and the first substrate.

2. The liquid crystal display device according to claim 1, wherein reflective display and transmissive display are performed at a same region of the liquid crystal layer.

3. The liquid crystal display device according to claim 2, wherein the diffusion layer is an adhesive layer through which the first λ/4 plate and the first substrate are bonded together.

4. The liquid crystal display device according to claim 3, wherein a surface of the first polarizer on the external light entry side is formed substantially flat to prevent light diffusion and is treated with a reflection prevention coating.

5. The liquid crystal display device according to claim 1, wherein the diffusion layer has a haze value of about 45% or higher.

6. The liquid crystal display device according to claim 1, wherein a light shield layer having an aperture corresponding to the second electrode is formed on the first substrate, and at least a portion of the second electrode that overlaps the aperture is formed as a transparent electrode.

7. The liquid crystal display device according to claim 1, further comprising a third λ/4 plate disposed between the second polarizer and the light guide plate, the third λ/4 plate having a retarded phase axis that is parallel or perpendicular to the retarded phase axis of the first λ/4 plate.

8. The liquid crystal display device according to claim 7, further comprising a reflective polarizer disposed between the second polarizer and the third λ/4 plate, the reflective polarizer having a reflection axis that is at a 45° angle with the retarded phase axis of the third λ/4 plate.

9. The liquid crystal display device according to claim 8, further comprising a first diffuser disposed between the second polarizer and the reflective polarizer.

10. The liquid crystal display device according to claim 9, wherein the first diffuser has a haze value of about 60% to about 85%.

11. The liquid crystal display device according to claim 9, wherein the first diffuser serves as an adhesive layer that bonds the reflective polarizer and the second polarize.

12. The liquid crystal display device according to claim 8, further comprising:
a first prism array disposed between the first diffuser and the light guide plate; and
a second prism array disposed between the first prism array and the light guide plate,
wherein prisms of the second prism array are arranged perpendicular to prisms of the first prism array.

13. The liquid crystal display device according to claim 12, further comprising a second diffuser disposed between the second prism array and the light guide plate.

14. The liquid crystal display device according to claim 13, wherein the second diffuser has a haze value of about 55% to about 85%.

15. The liquid crystal display device according to claim 1, wherein the backlight has light-emitting elements that emit light to an edge surface of the light guide plate, and wherein the light guide plate guides light from the light emitting elements towards the liquid crystal panel.

16. A liquid crystal display device comprising:
a liquid crystal panel, including:
a first substrate having a first electrode thereon,
a second substrate having a second electrode thereon, the first electrode on the first substrate facing the second electrode on the second substrate,
a liquid crystal layer interposed between the first electrode and the second electrode, the liquid crystal layer including liquid crystal with a negative dielectric constant anisotropy in which liquid crystal molecules are aligned vertically to a substrate surface when 0 V is applied across the first electrode and the second electrode, and are aligned inclinedly in a predetermined direction when a predetermined or higher voltage is applied across the first electrode and the second electrode, and
a first polarizer and a second polarizer sandwiching the first substrate and the second substrate therebetween, the first polarizer and the second polarizer having respective transmission axes crossing each other at a right angle;
a side-lit backlight that emits light towards the liquid crystal panel through a light guide plate, the backlight further having a reflection layer that reflects light that has passed through the liquid crystal panel and the light guide plate in that order;
a first phase difference generating member disposed between the first polarizer and the first substrate, the first phase difference generating member circularly polarizing light that has passed through the first polarizer;
a second phase difference generating member disposed between the second polarizer and the second substrate, the second phase difference circularly polarizing light that has passed through the second polarizer; and
a diffusion layer disposed between the first phase difference generating member and the first substrate.
